(19) United States
(12) Patent Application Publication
(10) Pub. No.: US 2019/0368747 A1
(43) Pub. Date: Dec. 5, 2019

(54) SYSTEM AND METHOD FOR CONTROLLING DEGREASING OF A KITCHEN VENTILATION SYSTEM

(71) Applicants: INTELLINOX INC., Québec (CA); INNUSCIENCE CANADA INC., Sainte-Julie (CA)

(72) Inventors: Mario ROUSSEAU, Québec (CA); Daniel COUILLARD, Sainte-Julie (CA)

(73) Assignees: INTELLINOX INC., Québec, QC (CA); INNUSCIENCE CANADA INC., Sainte-Julie, QC (CA)

(21) Appl. No.: 16/477,828

(22) PCT Filed: Jan. 12, 2018
(86) PCT No.: PCT/CA2018/050024

§ 371 Date: Jul. 12, 2019

Related U.S. Application Data
(60) Provisional application No. 62/445,961, filed on Jan. 13, 2017.

(51) Int. Cl. F24C 15/20; B08B 15/02; B08B 9/027

(52) U.S. Cl. CPC F24C 15/2057; B08B 9/027; B08B 15/02

(57) ABSTRACT

A method and system for degreasing a kitchen ventilation system includes determining degreasing setpoint(s) for a degreasing time interval, injecting degreasing agent within the kitchen ventilation system during the degreasing time interval and operating subsystem(s) of the kitchen ventilation system in accordance with the degreasing set point(s). The method and system can also include sensing operating condition(s) within the kitchen ventilation system, determining degreasing parameter(s) based on the sensed operation(s) and injecting degreasing agent with the kitchen ventilation system according to the degreasing parameter(s). Operating condition(s) can also be tracked over time to schedule degreasing at a future time. Safe degreasing conditions can also be detected prior to any injection of the degreasing agent.

### CROSS-REFERENCE TO RELATED APPLICATIONS

The present application claims priority from U.S. provisional patent application No. 62/445,961, filed on Jan. 13, 2017 and entitled “SYSTEM AND METHOD FOR CONTROLLING DEGREASING OF A KITCHEN VENTILATION SYSTEM”, the disclosure of which is hereby incorporated by reference in its entirety.

### TECHNICAL FIELD OF THE INVENTION

The present disclosure generally relates to a system and method for controlling degreasing of a kitchen ventilation system, and more particularly, a system and method in which a degreasing agent is intermittently injected into the kitchen ventilation system and in which the injection of the degreasing agent and/or the operation of the kitchen ventilation system is controlled.

### BACKGROUND

A kitchen ventilation system is adapted for treating air from kitchens. In particular, the kitchen ventilation system seeks to remove emissions introduced from cooking, such as grease, smoke and odors. A kitchen ventilation system is usually positioned close to a cooktop and typically includes a range hood, a filtering system, a duct subsystem and an airflow subsystem for causing flow of air, such as one or more fans.

FIG. 1 illustrates a common cooking arrangement in which a kitchen ventilation system 1 is positioned over a stovetop. A cooking receptacle 4 is currently being heated by a source of heat and emissions from the receptacle are received and moved by the kitchen ventilation system 1. The illustrated kitchen ventilation system 1 includes a range hood 12 and a duct subsystem 16, which guides the received emissions towards an exhaust 20 to be exited from the kitchen ventilation system 1. One or more filters 24 can further be provided at each inlet of the duct subsystem 16.

In many cases, the emissions received by the kitchen ventilation system 1 are not completely moved through the ventilation system 1 to the exhaust 20. Notably, grease emitted from cooking can be trapped at various locations within the kitchen ventilation system 1, such as within the range hood 12, the duct subsystem 16, fans 22 and filters 24. These trapped emissions decrease the effectiveness of the kitchen ventilation system 1 as well as introduce odors that can make the kitchen environment uncomfortable to work in as well as increase risk of fire hazard.

### BRIEF SUMMARY OF THE INVENTION

According to one aspect, there is provided a method of degreasing a kitchen ventilation system. The method includes determining at least one degreasing setpoint for a degreasing time interval, injecting at least one degreasing agent within the kitchen ventilation system during at least a portion of the degreasing time interval, and operating at least one subsystem of the kitchen ventilation system in accordance with the degreasing setpoint during the degreasing time interval.

In an embodiment, operating the at least one subsystem of the kitchen ventilation system in accordance with the at least one degreasing setpoint comprises controlling at least one subsystem of the kitchen ventilation system to maintain the degreasing setpoint during the degreasing time interval.

In an embodiment, the kitchen ventilation system comprises a duct subsystem; and injecting at least one degreasing agent within the kitchen ventilation system comprises injecting the at least one degreasing agent into the duct subsystem of the kitchen ventilation system. The at least one degreasing setpoint can comprise. a first speed of an airflow subsystem of the kitchen ventilation system and a second speed of the airflow subsystem of the kitchen ventilation system; and operating the at least one subsystem of the kitchen ventilation system can comprise: operating the airflow subsystem at the first speed while injecting the degreasing agent during a first portion of the degreasing time interval; and operating the airflow subsystem at the second speed while injecting the degreasing agent during a second portion of the degreasing time interval. The second speed of the airflow subsystem of the kitchen ventilation system can be greater than the first speed of the airflow subsystem. Operating the airflow subsystem of the kitchen ventilation system at the first speed while injecting the degreasing agent can be effective for providing degreasing action at an inlet region of the duct subsystem. The first speed can be a low speed or an off state of the airflow subsystem of the kitchen ventilation system. The airflow subsystem can be operated at the first speed for a post-injection time subinterval of the degreasing time interval, the post-injection time subinterval corresponding to an interval of time after completion of the injecting of the at least one degreasing agent. The post-injection time interval can have a duration greater than four hours. Operating the airflow subsystem of the kitchen ventilation system at the second speed while injecting the degreasing agent can be effective for providing degreasing action to a portion of duct subsystem downstream of the inlet region. The at least one degreasing setpoint can comprise a third speed of the airflow subsystem of the kitchen ventilation system, the third speed being greater than the first speed and the second speed; and operating the at least one subsystem of the kitchen ventilation system can comprise operating the airflow subsystem at the third speed while injecting the degreasing agent during a third portion of the degreasing time interval; and operating the airflow subsystem of the kitchen ventilation system at the second speed while injecting the degreasing agent can be effective for providing degreasing action at a conduit region of the duct subsystem of the kitchen ventilation system; while operating the airflow subsystem of the kitchen ventilation system at the third speed while injecting the degreasing agent can be effective for providing degreasing action at an exhaust region of the duct subsystem of the kitchen ventilation system.

In an embodiment, the at least one degreasing setpoint comprises a temperature setpoint of the kitchen ventilation system; and operating the at least one subsystem of the kitchen ventilation system can comprise operating a temperature control subsystem to substantially maintain the temperature setpoint within the kitchen ventilation system during the degreasing time interval. The temperature control subsystem can be operated to substantially maintain the temperature setpoint for a post-injection time subinterval of the degreasing time interval, the post-injection time subinterval corresponding to an interval of time after completion of the injecting of the at least one degreasing agent. The temperature setpoint can be a temperature of approximately 33 degrees Celsius or greater.

In an embodiment, the method further comprises determining the at least one degreasing setpoint in accordance with a preconfigured degreasing program.

In an embodiment, the method further comprises sensing at least one operating condition within the kitchen ventilation system and wherein the at least one degreasing setpoint is determined based on the sensed at least one operating condition within the kitchen ventilation system. The sensed at least one operating condition can comprise at least one of a type of cooking emissions received within the kitchen ventilation system and a quantity of cooking emissions received within the kitchen ventilation system. In an embodiment, sensing the at least one of the type of cooking emissions received within the kitchen ventilation system and the quantity of cooking emissions received within the kitchen ventilation system can be carried out using one or more optical sensors.

In an embodiment, the method further comprises detecting a presence of safe degreasing conditions prior to injecting the at least one degreasing agent, the detecting comprising detecting the presence of a filter at an inlet of a duct subsystem of the kitchen ventilation system. Detecting the presence of the filter can comprise receiving a signal from an occupancy sensor positioned at the inlet of the duct subsystem. Detecting the presence of the filter can comprise: operating an airflow subsystem of the kitchen ventilation system at a substantially high speed; measuring an air pressure variation within the duct subsystem of the kitchen ventilation system while operating the airflow subsystem at the substantially high speed; and detecting the presence of the filter if the measured air pressure variation exceeds an air pressure variation threshold. Determining the measured air pressure variation exceeding the air pressure variation threshold can be further indicative of the operational state of the airflow subsystem.

In an embodiment, the degreasing agent is a biological degreasing agent comprising at least one of bacteria and enzymes.

According to another aspect, there is provided a method for degreasing a kitchen ventilation system. The method includes sensing at least one operating condition within the kitchen ventilation system, determining a set of one or more degreasing parameters based on the at least one sensed operating condition, and injecting at least one degreasing agent within the kitchen ventilation system according to the set of one or more degreasing parameters.

In an embodiment, the sensed at least one operating condition comprises at least one of a type of cooking emissions received within the kitchen ventilation system and a quantity of cooking emissions received within the kitchen ventilation system. Sensing the at least one of the type of emissions received within the kitchen ventilation system and the quantity of emissions received within the kitchen ventilation system can be carried out using one or more optical sensors. In an embodiment, the one or more degreasing parameters can comprise at least one of an amount of the degreasing agent to be injected and the type of the degreasing agent to be injected.

In an embodiment, the sensing at least one operating condition within the kitchen ventilation system comprises tracking the operating condition over a tracking interval of time. The duration of the tracking interval of time for carrying out the tracking of the operating condition can be greater than a week. The kitchen ventilation system can comprise an airflow subsystem and a duct subsystem; wherein the at least one tracked operating condition can comprise a speed of the airflow subsystem and a presence of cooking emissions received within the duct subsystem; and determining the set of one or more degreasing parameters can comprise: identifying within the tracked operating conditions at least one degreasing-effective time interval during which the airflow subsystem is operating at a substantially low speed or is turned off and there is a non-presence of cooking emissions; and defining degreasing parameters to schedule carrying out degreasing effective for degreasing an inlet region of the duct subsystem during a future degreasing time interval corresponding to the identified degreasing-effective time interval. The identifying the degreasing-effective time interval can comprise identifying, within the tracked operating conditions, one or more time intervals each having a duration greater than four hours as effective for degreasing the inlet region of the duct subsystem. The at least one tracked operating condition can comprise a speed of an airflow subsystem of the kitchen ventilation system and a temperature within the kitchen ventilation system; and determining the set of one or more degreasing parameters can comprise: identifying within the tracked operating conditions at least one degreasing-effective time interval during which the airflow subsystem is operating at a substantially high speed and the temperature is greater than a predetermined temperature threshold; and defining degreasing parameters to schedule carrying out degreasing effective for degreasing a region of the duct subsystem downstream of an inlet region during a future degreasing time interval corresponding to the identified degreasing-effective time interval.

In an embodiment, the method further comprises detecting a presence of safe degreasing conditions prior to injecting the at least one degreasing agent, the detecting comprising detecting the presence of a filter at an inlet of a duct subsystem of the kitchen ventilation system. Detecting the presence of the filter can comprise receiving a reading from an occupancy sensor positioned at the inlet of the duct subsystem. Detecting the presence of the filter can comprise: operating an airflow subsystem of the kitchen ventilation system at a substantially high speed; measuring an air pressure variation within a duct subsystem of the kitchen ventilation system while operating the airflow subsystem at the substantially high speed; and detecting the presence of the filter if the measured air pressure variation exceeds an air pressure variation threshold. Determining the measured air pressure variation exceeding the air pressure variation threshold can be further indicative of the operational state of the airflow subsystem.

In an embodiment, the degreasing agent is a biological degreasing agent comprising at least one of bacteria and enzymes.

According to yet another aspect, there is provided a method for degreasing a kitchen ventilation system having an airflow subsystem and a duct subsystem. The method includes detecting within the kitchen ventilation system a presence of safe degreasing conditions, the detecting comprising detecting the presence of a filter at an inlet of the duct subsystem, and subsequent to detecting the presence of the safe degreasing conditions, injecting at least one degreasing agent within the duct subsystem during at least a portion of a degreasing time interval.

In an embodiment, detecting the presence of the filter comprises receiving a signal from an occupancy sensor positioned at the inlet of the duct subsystem.

In an embodiment, detecting the presence of the filter comprises: operating the airflow subsystem at a substantially high speed; measuring an air pressure variation within the duct subsystem of the kitchen ventilation system while operating the airflow subsystem at the substantially high speed; and detecting the presence of the filter if the measured air pressure variation exceeds an air pressure variation threshold. Determining the measured air pressure variation exceeding the air pressure variation threshold can be further indicative of the operational state of the airflow subsystem.

In an embodiment, the degreasing agent is a biological degreasing agent comprising at least one of bacteria and enzymes.

According to yet another aspect, there is provided a degreasing-enabled kitchen ventilation system that includes a plurality of subsystems of the kitchen ventilation system, including a duct subsystem and a degreasing agent injection subsystem, the degreasing agent injection subsystem including a degreasing agent supply in fluid communication with the duct subsystem and operable for selectively injecting at least one degreasing agent contained in the degreasing agent supply into the duct subsystem. The kitchen ventilation system also includes a degreasing controller module operatively connected to the degreasing agent injection subsystem and at least one other of the plurality of subsystems of the kitchen ventilation system. The degreasing controller module is configured for determining at least one degreasing setpoint, operating the at least one other of the plurality of subsystems of the kitchen ventilation system in accordance with the at least one degreasing setpoint, and operating the degreasing agent injection subsystem to inject the degreasing agent into the duct subsystem.

In an embodiment, the degreasing agent injection subsystem comprises a degreasing agent flow control member operatively connected to the degreasing controller module and mounted in a degreasing flow path between the degreasing agent supply and the duct subsystem, the degreasing agent flow control member being selectively configurable between a closed configuration and at least one open configuration to control the injection of the degreasing agent into the duct subsystem.

In an embodiment, the degreasing controller module is configured for: defining a degreasing time interval; operating the degreasing agent injection subsystem to inject the degreasing agent into the duct subsystem during the degreasing time interval; and operating the at least one other of the plurality of subsystems of the kitchen ventilation system in accordance with the at least one degreasing setpoint during the degreasing time interval.

In an embodiment, the plurality of subsystem of the kitchen ventilation system further comprises an airflow subsystem being operatively connected to and controllable by the degreasing controller module and being operable to cause airflow through the duct subsystem. The degreasing controller module can be configured to determine the at least one degreasing setpoint by determining a first speed of the airflow subsystem of the kitchen ventilation system and a second speed of the airflow subsystem of the kitchen ventilation system; and wherein the degreasing controller module can be configured for: operating the airflow subsystem at the first speed while injecting the degreasing agent during a first portion of the degreasing time interval; and operating the airflow subsystem at the second speed while injecting the degreasing agent during a second portion of the degreasing time interval. The e second speed of the airflow subsystem of the kitchen ventilation system can be greater than the first speed of the airflow subsystem. Operating the airflow subsystem of the kitchen ventilation system at the first speed while injecting the degreasing agent can be effective for providing degreasing action at an inlet region of the duct subsystem. The first speed can be a low speed or an off state of the airflow subsystem of the kitchen ventilation system. The degreasing controller module can be configured for: operating the airflow subsystem at the first speed for a post-injection time subinterval of a degreasing time interval, the post-injection time subinterval corresponding to an interval of time after completion of the injecting of the at least one degreasing agent. The post-injection time interval can have a duration greater than four hours. Operating the airflow subsystem of the kitchen ventilation system at the second speed while injecting the degreasing agent can be effective for providing degreasing action to a portion of duct subsystem downstream of the inlet region. The at least one degreasing setpoint can comprise a third speed of the airflow subsystem of the kitchen ventilation system, the third speed being greater than the first speed and the second speed. The degreasing controller module can be configured for operating the airflow subsystem at the third speed while injecting the degreasing agent during a third portion of the degreasing time interval; and operating the airflow subsystem of the kitchen ventilation system at the second speed while injecting the degreasing agent can be effective for providing degreasing action at a conduit region of the duct subsystem of the kitchen ventilation system; and operating the airflow subsystem of the kitchen ventilation system at the third speed while injecting the degreasing agent can be effective for providing degreasing action at an exhaust region of the duct subsystem of the kitchen ventilation system.

In an embodiment, the plurality of subsystems of the kitchen ventilation system comprises a temperature control subsystem being operatively connected to and controllable by the degreasing controller module; wherein the degreasing controller module is configured to determine the at least one degreasing setpoint by determining a temperature setpoint of the kitchen ventilation system; and wherein the degreasing controller is configured to operate the at least one other of the plurality of subsystems of the kitchen ventilation system by operating the temperature control subsystem to obtain the temperature setpoint within the kitchen ventilation system. The temperature setpoint can be a temperature of approximately 33 degrees Celsius or greater.

In an embodiment, the degreasing controller module is configured to determine the at least one degreasing setpoint according to a preconfigured degreasing program.

In an embodiment, the kitchen ventilation system further comprises at least one ventilation condition sensor operable to sense at least one operating condition within the kitchen ventilation system, the at least one ventilation condition sensor being operatively connected to the degreasing controller module to transmit the at least one ventilation condition to the degreasing controller module. The degreasing controller module can be configured to determine the at least one degreasing set point based on the operating condition within the kitchen ventilation system. The sensed at least one operating condition can comprise at least one of a type of cooking emissions received within the kitchen ventilation system and a quantity of cooking emissions received within the kitchen ventilation system. The sensed at least one operating condition can comprise at least one of a type of cooking emissions received within the kitchen ventilation system and a quantity of cooking emissions received within the kitchen ventilation system.

In an embodiment, at least one subsystem of the kitchen ventilation system comprises a filter detection subsystem operatively connected to the degreasing controller module and being operable to transmit a detected condition related to the presence of a filter at an inlet of the duct subsystem to the degreasing controller module. The degreasing controller can be further configured for: detecting a presence of safe degreasing conditions from detecting the presence of the filter at the inlet of the duct subsystem of the kitchen ventilation system based on the transmitted detected condition. The degreasing controller can be configured for preventing the operating of the degreasing agent injection subsystem to inject the degreasing agent into the duct subsystem unless a presence of safe degreasing conditions is detected. The filter detection subsystem can comprise an occupancy sensor positioned at the inlet of the duct subsystem being operable to detect the presence of the filter. The plurality of subsystems of the kitchen ventilation system can comprise an airflow subsystem being operatively connected to and controllable by the degreasing controller module and being operable to cause airflow through the duct subsystem. The filter detection subsystem can comprise an air pressure sensor operable to measure the air pressure variation within the duct subsystem, the air pressure variation being the detected condition; and wherein the degreasing controller is configured for detecting the presence of the filter by: operating the airflow subsystem of the kitchen ventilation system at a substantially high speed; measuring the pressure variation within the duct subsystem of the kitchen ventilation system while operating the airflow subsystem at the substantially high speed; and detecting the presence of the filter if the measured air pressure variation exceeds an air pressure variation threshold. The degreasing controller can be configured for also determining an operational state of the airflow subsystem from the measured air pressure variation exceeding the air pressure variation threshold.

In an embodiment, the degreasing agent is a biological degreasing agent comprising at least one of bacteria and enzymes.

According to yet another aspect, there is provided a degreasing enabled kitchen ventilation system that includes at least one condition sensor configured for sensing at least one operating condition within the kitchen ventilation system a plurality of subsystems of the kitchen ventilation system, including a duct subsystem and a degreasing agent injection subsystem, the degreasing agent injection subsystem including a degreasing agent supply in fluid communication with the duct subsystem and operable for selectively injecting at least one degreasing agent contained in the degreasing agent supply into the duct subsystem. The kitchen ventilation system further includes a degreasing controller module operatively connected to the at least one condition sensor and the degreasing agent injection subsystem. The degreasing controller module is configured for determining a set of one or more degreasing parameters based on the at least one sensed condition and operating the degreasing agent injecting subsystem to inject the degreasing agent into the duct subsystem according to the set of one or more degreasing parameters.

In an embodiment, the sensed at least one operating condition comprises at least one of a type of cooking emissions received within the kitchen ventilation system and a quantity of cooking emissions received within the kitchen ventilation system. The at least one condition sensor can comprise one or more optical sensors; and the at least one of the type of emissions received within the kitchen ventilation system and the quantity of emissions received within the kitchen ventilation system can be sensed by the one or more optical sensors. The one or more degreasing parameters can comprise at least one of an amount of the degreasing agent to be injected and the type of the degreasing agent to be injected.

The at least one condition sensor can be configured to sense the at least one operating condition by tracking the operating condition over a tracking interval of time. The at least one condition sensor can be configured to perform tracking of the operating condition over a duration of the tracking interval of time of greater than a week. The plurality of subsystems of the kitchen ventilation system can comprise an airflow subsystem operatively connected and controllable by the degreasing controller module. The at least one tracked operating condition can comprise a speed of the airflow subsystem and a presence of cooking emissions received within the duct subsystem; and the degreasing controller module can be configured to determine the set of one or more degreasing parameters by: identifying within the tracked operating conditions at least one degreasing-effective time interval during which the airflow subsystem is operating at a substantially low speed or is turned off and there is a non-presence of cooking emissions; and defining degreasing parameters to schedule carrying out degreasing effective for degreasing an inlet region of the duct subsystem during a future degreasing time interval corresponding to the identified degreasing-effective time interval. The degreasing controller module can be configured to identify the degreasing-effective time interval by identifying, within the tracked operating conditions, one or more time intervals each having a duration greater than four hours as effective for degreasing the inlet region of the duct subsystem. The plurality of subsystems of the kitchen ventilation system can comprise an airflow subsystem; wherein the at least one tracked operating condition can comprise a speed of the airflow subsystem of the kitchen ventilation system and a temperature within the kitchen ventilation system; and wherein the degreasing controller module can be configured to determine the set of one or more degreasing parameters by: identifying within the tracked operating conditions at least one degreasing-effective time interval during which the airflow subsystem is operating at a substantially high speed and the temperature is greater than a predetermined temperature threshold; and defining degreasing parameters to schedule carrying out degreasing effective for degreasing a region of the duct subsystem downstream of an inlet region during a future degreasing time interval corresponding to the identified degreasing-effective time interval.

In an embodiment, the plurality of subsystems of the kitchen ventilation system comprises a filter detection subsystem operatively connected to the degreasing controller and being operable to transmit a detected condition related to the presence of a filter at an inlet of the duct subsystem to the degreasing controller module. The degreasing controller can be further configured for: detecting a presence of safe degreasing conditions from detecting the presence of the filter at the inlet of the duct subsystem of the kitchen ventilation system based on the transmitted detected condition. In an embodiment, the degreasing controller can be configured for preventing the operating of the degreasing agent injection subsystem to inject the degreasing agent into the duct subsystem unless a presence of safe degreasing conditions is detected. In an embodiment, the filter detection subsystem can comprise an occupancy sensor positioned at the inlet of the duct subsystem being operable to detect the presence of the filter. The plurality of subsystems of the kitchen ventilation system can comprise an airflow subsystem being operatively connected to and controllable by the degreasing controller module and being operable to cause airflow through the duct subsystem. The filter detection subsystem can comprise an air pressure sensor operable to measure the air pressure variation within the duct subsystem, the air pressure variation being the detected condition; and wherein the degreasing controller is configured for detecting the presence of the filter by: operating the airflow subsystem of the kitchen ventilation system at a substantially high speed; measuring the air pressure variation within the duct subsystem of the kitchen ventilation system while operating the airflow subsystem at the substantially high speed; and detecting the presence of the filter if the measured air pressure variation exceeds an air pressure variation threshold. The degreasing controller can be configured for also determining an operational state of the airflow subsystem from the measured air pressure variation exceeding the air pressure variation threshold.

In an embodiment, the degreasing agent is a biological degreasing agent comprising at least one of bacteria and enzymes.

According to yet another aspect, there is provided a degreasing-enabled kitchen ventilation system having a plurality of subsystems including: a duct subsystem having an inlet, a degreasing agent injection subsystem including a degreasing agent supply in fluid communication with the duct subsystem and operable for selectively injecting at least one degreasing agent contained in the degreasing agent supply into the duct subsystem and a filter detection subsystem operable to detect a condition related to the presence of a filter at the inlet of the duct subsystem. The kitchen ventilation system further includes a degreasing controller module operatively connected to the degreasing agent injection subsystem and the filter detection subsystem to receive the detected condition therefrom. The degreasing controller is configured for detecting a presence of safe degreasing conditions from detecting the presence of a filter at the inlet of the duct subsystem of the kitchen ventilation system based on the received detected condition.

In an embodiment, the degreasing controller is configured for preventing operation of the degreasing agent injection subsystem to inject the degreasing agent into the duct subsystem unless a presence of safe degreasing conditions is detected.

In an embodiment, the filter detection subsystem comprises an occupancy sensor positioned at the inlet of the duct subsystem being operable to detect the presence of the filter.

In an embodiment, the plurality of subsystems of the kitchen ventilation system comprises an airflow subsystem being operatively connected to and controllable by the degreasing controller module and being operable to cause airflow through the duct subsystem; and wherein the filter detection subsystem comprises an air pressure sensor operable to measure the air pressure variation within the duct subsystem; and wherein the degreasing controller is configured for detecting the presence of the filter by: operating the airflow subsystem of the kitchen ventilation system at a substantially high speed; measuring the air pressure variation within the duct subsystem of the kitchen ventilation system while operating the airflow subsystem at the substantially high speed; and detecting the presence of the filter if the measured air pressure variation exceeds an air pressure variation threshold. The degreasing controller can be configured for also determining an operational state of the airflow subsystem from the measured air pressure variation exceeding the air pressure variation threshold.

In an embodiment, the degreasing agent is a biological degreasing agent comprising at least one of bacteria and enzymes.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates a common cooking arrangement that includes a prior art kitchen ventilation system; and

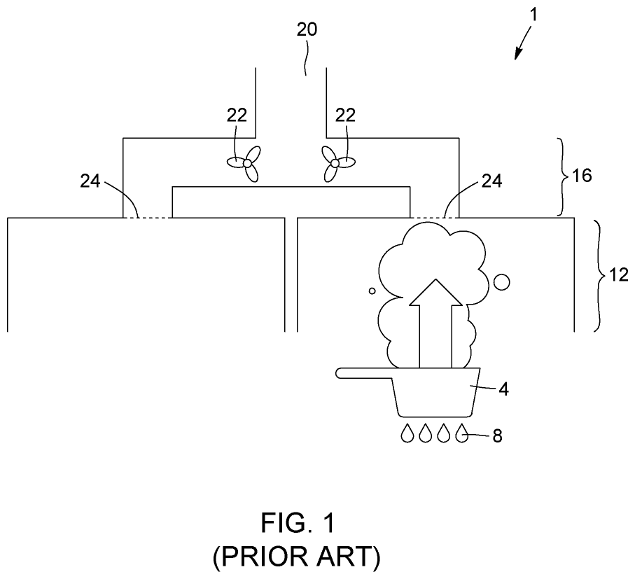

FIG. 2 illustrates a schematic diagram of a degreasing-enabled kitchen ventilation system according to an example embodiment;

FIG. 3 illustrates a flowchart of the operational steps of an exemplary method for one degreasing cycle of the duct subsystem;

FIG. 4 illustrates a flowchart of the operational steps of an exemplary method for carrying out degreasing of a kitchen ventilation system;

FIG. 5 illustrates a schematic diagram of a degreasing capable kitchen ventilation system according to an alternative example embodiment that is operable to detect presence of a filter at the inlet; and

FIG. 6 illustrates a flowchart of the operational steps of an exemplary method for detecting the presence of the filter at the inlet of the duct subsystem.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

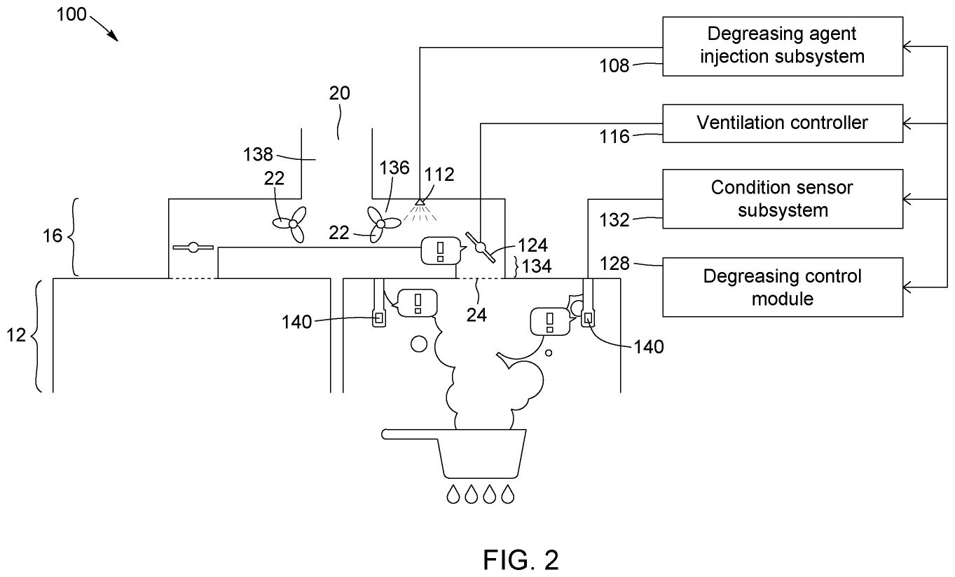

FIG. 2 illustrates a schematic diagram of a degreasing-capable kitchen ventilation system 100 according to one example embodiment. The degreasing-capable kitchen ventilation system 100 includes a plurality of subsystems. These subsystems include the duct subsystem 16 and a degreasing agent injection subsystem 108 that is configured to inject a degreasing agent into the kitchen ventilation system 100.

The degreasing agent injection subsystem 108 includes a degreasing agent supply that stores a supply of at least one degreasing agent. The degreasing agent supply is in fluid communication with the duct subsystem 16 of the kitchen ventilation system and is operable for selectively injecting at least one the degreasing agent contained in the degreasing agent supply into the duct subsystem 16.

In one example embodiment, the degreasing agent injection subsystem includes a degreasing agent flow control member, such as valve, that is mounted in a degreasing flowpath between the degreasing agent supply and the duct subsystem 16. The flow member can be electrically or electronically controlled. The flow member is selectively configurable between a closed configuration and at least one open configuration. In the closed configuration, the degreasing agent flow control member prevents injection of the degreasing agent from the supply into the duct subsystem. In the open configuration, the degreasing agent flow control member permits injection of the degreasing agent from the supply into the duct subsystem.

The degreasing agent is effective for breaking down and degrading grease trapped within the kitchen ventilation system 100. For example, the degreasing agent may be a biotechnological composition containing, without limitation, a surfactant or a mixture of surfactants. The composition may include one or more bacterial cultures effective for degrading fat, oil and greases. The composition may include one or more enzymatic extracts able to hydrolyse triacyglycerol. The composition may be supplemented with building agents. The composition may be a pH neutral biological degreasing agent. The degreasing agent may be injected into the kitchen ventilation system 100 in a liquid form. The degreasing agent may be injected in as droplets of various sizes ranging from medium to large size droplets to a very fine mist. While the example of FIG. 2 shows a single injection nozzle 112 for injecting the degreasing agent being positioned within the duct subsystem 16, it will be understood that a plurality of injection nozzles 112 may be provided and that the injection nozzle 112 may be located elsewhere within the kitchen ventilation system 100, such as within the range hood 12, near the exhaust 20, or in proximity of a filter 24 or fan 22.

The degreasing-capable kitchen ventilation system 100 further includes a kitchen ventilation controller 116 for controlling one or more operating conditions within the kitchen ventilation system. An operating condition refers to a physical condition within the kitchen ventilation system. The kitchen ventilation controller 116 may control the one or more operating conditions within the kitchen ventilation system 100 by adjusting the operating state of one or more subsystems of the kitchen ventilation system 100. The operating state of a subsystem of the kitchen ventilation system 100 refers to how that subsystem is currently operating.

The kitchen ventilation controller 116 can be operatively connected to, and configured to operate, an airflow subsystem to adjust or control the air flowrate (operating condition) through the range hood 12 and duct subsystem 16 by controlling the speed (operating state) of the airflow subsystem of the kitchen ventilation system 100 (ex: adjusting the fan speed) and/or by modulating one or more damper(s) 124 (ex: adjusting their configuration and thereby the air flowrate). The airflow subsystem is one of the plurality of subsystems of the kitchen ventilation system.

The kitchen ventilation controller 116 can be configured to adjust or control the amount of filtering (operating condition) applied to emissions received within the kitchen ventilation system 100 by controlling the open/closed state of one or more dampers 124 (operating state). The open/closed state of the one or more dampers 124 or degree of openness of the dampers 124 can also be used to control the air flowrate through the range hood 12.

The airflow subsystem described herein can include the fans 22 for moving air through the kitchen ventilation system 100, the one or more dampers 124, or a combination thereof. In various embodiments described herein, the airflow subsystem can be operated at different speeds. The speed of the airflow subsystem can refer to the flowrate of air through the duct subsystem 16, the speed of rotation of the fan(s) and/or an actuation position of the dampers 124, depending on the context. It will be appreciated that adjusting the speed of the rotation of the fans and the actuation position of the dampers 124, individually or together, causes a change in the flowrate of air through the duct subsystem 16.

The kitchen ventilation controller 116 can be operatively connected to, and configured to operate, a temperature control subsystem to adjust or control the temperature (operating condition) within one or more areas of the kitchen ventilation system 100. For example, the temperature control subsystem may be a heat exchanger that can circulate (operating state) a heat exchange fluid in proximity of the range hood 12 or duct subsystem 16 to adjust the temperature thereof. The heat exchanger may be a heated water circulation subsystem that is operable to raise the temperature within the kitchen ventilation system 100. Water may also be recirculated in the filters of the ventilation system to heat these filters, whereas such filters are typically used to recover heat from the kitchen ventilation system. The temperature control subsystem can be one of the plurality of subsystems of the kitchen ventilation system 100.

The kitchen ventilation controller 116 can be operatively connected to, and configured to operate, a humidity control subsystem to adjust or control the level humidity within one or more areas of the kitchen ventilation system 100. For example, the humidity control subsystem can inject atomized water particles into the ventilation system. The humidity control subsystem can be one of the plurality of subsystems of the kitchen ventilation system 100.

The kitchen ventilation controller 116 can be operatively connected to, and configured to operate, a water rinsing subsystem configured to inject water to remove soot, dust or other non-degradable particles. The kitchen ventilation system 100 can further include a gutter system to collect water discharged from the rinsing. The water rising subsystem can be one of the plurality of subsystems of the kitchen ventilation system 100.

It was observed that the effectiveness of the degreasing agent varied according to the operating conditions present within kitchen ventilation system 100. Some operating conditions also caused the degreasing agent to be more effective at degreasing one portion of the kitchen ventilation system 100 compared to another portion of the kitchen ventilation system 100.

According to various example embodiments, the method and system for degreasing the kitchen ventilation system 100 includes operating at least one subsystem of the kitchen ventilation system 100 in order to obtain, adjust or maintain at least one operating state of the kitchen ventilation system 100 during a degreasing time interval.

The degreasing time interval corresponds to an interval of time during which the degreasing agent is injected within the kitchen ventilation system. It will be understood that the actual injecting of the degreasing agent can occur during a portion of the entire degreasing time interval. This portion corresponds to an injection sub-interval of the degreasing time interval. The degreasing time interval may also include a pre-injection sub-interval, which corresponds to an interval of time immediately preceding the injection of degreasing agent during the injection sub-interval. The degreasing time interval may also include a post-injection sub-interval, which corresponds to an interval of time immediately following the injection of the degreasing agent during the injection sub-interval.

At least one degreasing setpoint of the kitchen ventilation system is determined for a degreasing time interval and the kitchen ventilation system (or subsystems thereof) is operated in accordance with the at least one degreasing setpoint. According to one example embodiment, the operation of the kitchen ventilation system is controlled to maintain the at least one degreasing setpoint during the degreasing time interval.

The at least one degreasing setpoint may include an operating state setpoint that defines the operating state of a subsystem of the kitchen ventilation system 100. For example, the degreasing setpoint may include a speed of the airflow subsystem (ex: adjusting the fan speed to a setpoint RPM and/or actuation of the dampers). The degreasing setpoint may correspond to an operating state of the kitchen ventilation system that is known to be effective for achieving a desired degreasing result.

Additionally, or alternatively, the at least one degreasing setpoint may include an operating condition setpoint that defines the operating condition within the kitchen ventilation system 100. Accordingly, the operating state of one or more subsystems of the kitchen ventilation system 100 may be operated and/or adjusted to obtain and/or maintain the operating condition setpoint. For example, the operating condition setpoint may include a target temperature within an area of the kitchen ventilation system 100 and the temperature control subsystem is controlled so that the target temperature is obtained/maintained.

It will be understood that operating the kitchen ventilation system in accordance with the at least one degreasing setpoint can include operating a subsystem at a given operating state defined by the degreasing setpoint.

Operating the kitchen ventilation system in accordance with the at least one degreasing setpoint can also include adjusting the operating state of one or more subsystems so as to obtain an operating condition defined by the degreasing setpoint. In some example embodiments, the one or more subsystems can be operated to obtain the operating condition at a given point in time (ex: the beginning of a degreasing time interval), and the operating of the one or more subsystems is not further adjusted subsequently for some time.

Operating the kitchen ventilation system in accordance with the at least one degreasing setpoint can also include controlling the operating state of one or more subsystems so that an operating condition defined by the degreasing setpoint is maintained. As described elsewhere, the operating conditions within the kitchen ventilation system can be measured using sensors, and the operating of the one or more subsystems is intermittently adjusted over time in accordance with the measured conditions to maintain the degreasing setpoint. It will be appreciated that when controlling the one or more subsystems to maintain the degreasing setpoint involves a feeding back the measured conditions to control the operation of the one or more subsystems.

The kitchen ventilation system 100 can include a computer-implemented degreasing controller module 128 that is configured for determining the operating setpoint(s). The controller module 128 is operatively connected to, and in signal communication, with the kitchen ventilation controller 116. Accordingly, the degreasing controller module 128 sends control signals to the ventilation controller 116 that cause the ventilation controller 116 to operate one or more subsystems of the kitchen ventilation system 100.

The degreasing controller module 128 is also operatively connected to and in signal communication with the degreasing agent injection subsystem 108 and is configured to send control signals to operate the degreasing agent injection subsystem 108 to selectively perform injection of degreasing agent.

The degreasing controller module 128 may be implemented in hardware or software, or a combination of both. It may be implemented on a programmable processing device, such as a microprocessor or microcontroller, Central Processing Unit (CPU), Digital Signal Processor (DSP), Field Programmable Gate Array (FPGA), general purpose processor, and the like. In some embodiments, the programmable processing device can be coupled to program memory, which stores instructions used to program the programmable processing device to execute the controller. The program memory can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, and optical media.

Various embodiments described herein are presented as methods for degreasing a duct subsystem of a kitchen ventilation system. It will be understood that the degreasing controller module 128 is configured for operating the degreasing agent injection subsystem to inject the degreasing agent into the duct subsystem 16. The degreasing controller module 128 is further configured to operate at least one other of the plurality of subsystems of the kitchen ventilation system in accordance with at least one degreasing setpoint. Accordingly, the degreasing controller module 128 is configured to operate the degreasing agent injection subsystem and the at least one other subsystem according to such methods. For example, the degreasing controller module 128 can be appropriately programmed (ex: according to logic defined in program code) so that executing the program causes operation in the manner described herein.

In some embodiments, the degreasing controller module 128 and the ventilation controller 116 can be integrated together within a single controller module.

Referring back to FIG. 2, the system 100 may include a condition sensor subsystem 132 that is configured to sense one or more operating conditions within the kitchen ventilation system 100. The degreasing controller module 128 is operatively connected to and in signal communication with the condition sensor subsystem 132. The sensed operating conditions can be received at the degreasing controller module 128. The degreasing controller module 128 can be configured to determine the at least one degreasing setpoint based on the operating condition within the kitchen ventilation system and then sends control signals to operate the degreasing agent injection subsystem 108 and/or the ventilation controller 116, which further sends control signals to operate or adjust the operating state of one or more subsystems in accordance with the degreasing setpoint(s).

It will be understood that the degreasing setpoint may be define a single target setpoint that is to be obtained or maintained. Alternatively, the degreasing setpoint may be define a range having an upper bound and a lower bound, and the setpoint is maintained as long as an operating condition within the kitchen ventilation system 100 or an operating state of a subsystem of the kitchen ventilation system 100 is maintained within the defined range.

The at least one degreasing setpoint for the degreasing time interval may include at least one pre-injection setpoint and the operating state of one or more subsystems of the kitchen ventilation system 100 is operated to achieve the pre-injection setpoint prior to carrying out the injection of the degreasing agent into the kitchen ventilation system 100. For example, the pre-injection subinterval of the degreasing time interval corresponds to an initialisation phase in which desired operating conditions associated to the one or more pre-injection setpoints are obtained within the kitchen ventilation system 100 before commencing injection of the degreasing agent. It will be appreciated that the pre-injection setpoint during the pre-injection subinterval provides an environment that is favorable for degreasing prior to the degreasing agent being injected into the kitchen ventilation system 100.

The at least one degreasing setpoint for the degreasing time interval may include at least one injection setpoint and the operating state of one or more subsystems of the kitchen ventilation system 100 is operated and, in some implementations, controlled to obtain or maintain the injection setpoint during the injection subinterval in which injection of the degreasing agent is carried out. Obtaining or maintaining the injection setpoint can provide an environment that is favourable for degreasing. Alternatively, or additionally, obtaining or maintaining the injection setpoint can provide an environment that is effective for achieving desired dispersion of the degreasing agent within the kitchen ventilation system (ex: promoting dispersion to various areas of the kitchen ventilation system vs. concentrating dispersion to one or more select areas of the kitchen ventilation system). In some embodiments, the injection setpoint can be the same as the pre-injection setpoint.

The at least one degreasing setpoint for the degreasing time interval may include at least one post-injection setpoint and the operating state of one or more subsystems of the kitchen ventilation system 100 is operated to obtain or maintain the post-injection setpoint during the post-injection subinterval after the injection of the degreasing agent has been completed. Although the degreasing agent has already been injected, some time may be required for the degreasing agent to complete its degreasing action on grease accumulated within the kitchen ventilating system 100. During this post-injection subinterval, obtaining or maintaining the post-injection setpoint can provide an environment that allows the degreasing agent to effectively carry out the degreasing action.

According to various example embodiments, one or more degreasing setpoints may be time-variant.

The at least one operating setpoint can be determined based on an amount of degreasing agent to be injected, the type of degreasing agent to be injected and/or the area of the kitchen ventilation system to be targeted.

The degreasing controller module 128 can be configured to determine the at least one operating setpoint as described herein. The degreasing controller module 128 can also be configured to define the degreasing time interval as described herein, operate the degreasing agent injection subsystem to inject the degreasing agent into the duct subsystem during the degreasing time interval and to operate the at least one other of the plurality of subsystems of the kitchen ventilation system in accordance with the at least one degreasing setpoint during the degreasing time interval.

According to one example embodiment, the at least one degreasing set point are determined according to a preconfigured degreasing program. The expected use of the kitchen ventilation system can be determined (ex: the types of cooking to be carried out, when cooking will be carried out, etc.). A degreasing program that is suitable for the expected use can then be preconfigured or preselected by a human operator. It will be understood that once the preconfigured degreasing program is set, the program will typically remain unchanged for an extended amount of time. The preconfigured degreasing program can be modified by the human operator based on changes in the expected use. The preconfigured degreasing program can be stored within the degreasing controller module 128.

According to another example embodiment, at least one operating condition within the kitchen ventilation system is sensed and the at least one degreasing set point is automatically determined based on the operating condition within the kitchen ventilation system. The at least one operating setpoint can also be automatically and dynamically adjusted over time based on the sensed operating condition. The determining of the at least one degreasing set point can be part of determining degreasing parameters, as described elsewhere herein. The degreasing controller module 128 can be configured to determine the at least one degreasing setpoint based on the sensed operating condition within the kitchen ventilation system.

According to various example embodiment, a degreasing operation includes a first degreasing setpoint that defines a first speed of the airflow subsystem of the kitchen ventilation system. The airflow subsystem of the kitchen ventilation system is operable to cause a flow of fluid through the duct subsystem 16 of the kitchen ventilation system. For example, the airflow subsystem of the kitchen ventilation system includes the one or more fans 22 for causing displacement of fluid through the duct subsystem 16. The speed of the airflow subsystem of the kitchen includes a fan speed thereof.

The first speed of the airflow subsystem of kitchen ventilation system 100 can be a low speed or off state of the airflow subsystem of the kitchen ventilation system 100. The airflow subsystem is operated at the first speed during an interval of time while injecting the degreasing agent. It was observed that the first speed of the airflow subsystem of the kitchen ventilation system 100 is effective for targeting for degreasing purposes an inlet region 134 of the duct subsystem 16. This inlet region 134 corresponds to a space of the duct subsystem 16 in proximity of the filter 24 and range hood 12 where cooking emissions will initially enter the duct subsystem 16. It will be appreciated that the low speed or off state of the airflow subsystem reduces the dispersion and flow of the degreasing agent that is injected in vaporized form. Accordingly, the degreasing agent that is injected in proximity of the inlet region 134 will remain within this region and will be effective to provide degreasing action at the inlet region 134. In such an example, the low speed or off state of the airflow setpoint can be a first injection setpoint. Furthermore, a post-injection setpoint can also have the first speed of the airflow setpoint so that the degreasing agent can remain at the inlet region 134 for a sufficient amount of time to provide effective cleaning.

The degreasing operation may also include a second degreasing setpoint that defines a second speed of the airflow subsystem of the kitchen ventilation system. The second speed of the airflow subsystem of the kitchen ventilation system 100 can be a speed that is greater than the first speed of the airflow subsystem. The airflow subsystem can also be operated at the second speed during an interval of time while injecting the degreasing agent. It will be appreciated that the greater speed of the airflow subsystem promotes dispersion of the degreasing agent that is injected in the vaporized form. The second speed being greater than the first speed causes the degreasing agent injected into the duct subsystem 16 to be carried by the fluid flow to regions of the duct subsystem 16 that are downstream of the inlet region 134.

The second speed of the airflow subsystem of the kitchen ventilation system 100 can be a medium speed that is effective to cause a large portion of the injected degreasing agent to be dispersed over a conduit region 136 of the duct subsystem 16. The conduit region 136 can correspond to the region between the inlet region 134 and an exhaust region 138 and provides a fluid channel between the two regions 134, 138. The second speed can be a medium speed of the airflow subsystem of the kitchen ventilation system 100. The second speed of the airflow setpoint can be a second injection setpoint.

The degreasing operation may further include a third degreasing setpoint that defines a speed of the airflow subsystem of the kitchen ventilation system. The third speed of the airflow subsystem of the kitchen ventilation system 100 can be a speed that is greater than second speed of the airflow subsystem. It will be appreciated that an even greater speed causes the degreasing agent injected into the duct subsystem 16 to be carried even further downstream within the duct subsystem 16. The third speed can be effective for causing the injected degreasing agent to be carried to an exhaust region 138 of the duct subsystem 16. The exhaust region 138 can be the space surrounding the exhaust 20 where fluid exits the duct subsystem 16 to an outside environment. The third speed can be a high speed or maximum speed of the airflow subsystem.

A complete degreasing cycle according to an example includes operating the airflow subsystem at at least the first speed during a first interval of time while injecting the degreasing agent and at least the second speed for a second interval of time while injecting the degreasing agent. The airflow subsystem can be further operated at the third speed for a third interval of time while injecting the degreasing agent. The cycle can further include maintaining the first speed for a sufficiently long interval time after operating the airflow subsystem at the first speed while injecting the degreasing agent. As described elsewhere, maintaining the first speed after completing injecting the degreasing agent allows time for the degreasing agent to clean effectively at the inlet region 134.

Within the complete degreasing cycle, the airflow subsystem can be operated in an order in which airflow subsystem is operated at the first speed last. In one embodiment, the airflow subsystem is first operated at the third fan speed for a first injection time interval, followed by operating at the second fan speed for a second injection time interval, followed by operating at the first fan speed for a third injection time interval, further followed by a time interval in which the first speed is maintained (without injecting the degreasing agent). As described elsewhere herein, starting with the third fan speed of the airflow subsystem is also useful for determining an operational state of the airflow subsystem.

The degreasing controller module 128 can be operatively connected to the airflow subsystem and the airflow subsystem is controllable by the degreasing controller module 128. The degreasing controller module 128 is configured to operate the airflow subsystem at the first speed, second speed and/or third speed while injecting the degreasing agent according to various embodiments described herein. In some implementations, the airflow subsystem can operate at less than or more than three speeds.

The degreasing controller module 128 may be configured to determine the at least one degreasing setpoint by defining a first speed of the airflow subsystem of the kitchen ventilation system and a second speed of the airflow subsystem of the kitchen ventilation system. The degreasing controller module 128 may also be configured for operating the airflow subsystem at the first speed while injecting the degreasing agent during a first portion of the degreasing time interval and operating the airflow subsystem at the second speed while injecting the degreasing agent during a second portion of the degreasing time interval.

The degreasing controller module 128 may further be configured to operate the airflow subsystem at the first speed for a post-injection time subinterval of a degreasing time interval. The post-injection time subinterval corresponds to an interval of time after completion of the injecting of the at least one degreasing agent.

The degreasing controller module 128 may further be configured to operate the airflow subsystem at the third speed while injecting the degreasing agent during a third portion of the time interval.

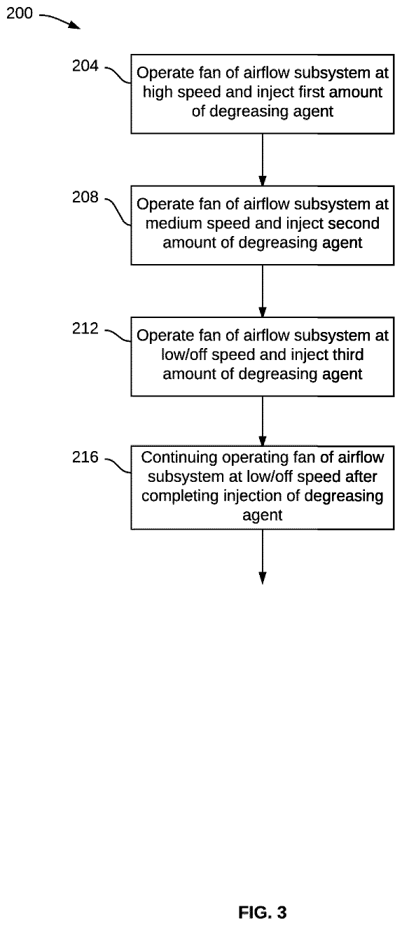

Referring now to FIG. 3, therein illustrated is a flowchart of the operational steps of a method 200 for one degreasing cycle of the duct subsystem 16 according to an example embodiment.

At step 204, the airflow subsystem of the kitchen ventilation system is operated at a high or maximum speed (i.e. the third speed described herein) while injecting degreasing agent into the duct subsystem 16. As described elsewhere herein, this speed is effective for dispersing degreasing agent at the exhaust region 138 of the duct subsystem 16.

At step 208, after completing step 204, the airflow subsystem of the kitchen ventilation system is operated at a medium speed (i.e. the second speed described herein) while injecting degreasing agent into the duct subsystem 16. As described elsewhere herein, this speed is effective for dispersing degreasing agent at the conduit region 136 of the duct subsystem 16.

At step 212, after completing step 208, the airflow subsystem of the kitchen ventilation system is operated at a low speed (i.e. the first speed described herein) while injecting degreasing agent into the duct subsystem 16. As described elsewhere herein, this speed is effective for dispersing degreasing at an inlet region 134 of the duct subsystem 16.

At step 216, immediately after completing step 212 and consecutive thereto, the airflow subsystem of the kitchen ventilation system is continued to operate the low speed even after competing injection of the degreasing agent into the duct subsystem 16. As described elsewhere herein, this provides sufficient time for the degreasing agent to clean at the inlet region 134.

It will be understood that the steps 204, 208 and 212 can be carried out consecutively in time. However, these steps can also be staggered in time. That is, after completing steps 204 or 208, cooking emissions can be received within the duct subsystem 16 and a speed of the airflow subsystem is chosen based on the amount/type of cooking emissions that can be different from the speed in the next step of method 200. Method 200 can then be resumed at a later time when favourable operating conditions within the kitchen ventilation system are present. The degreasing controller module 128 can be configured (ex: appropriately programmed) to operate various subsystems of the kitchen ventilation system to carry out the steps of method 200.

According to another example application, the operating setpoint is set to an operating temperature of the kitchen ventilation system 100. It was observed that having a temperature of 33 degrees Celsius or higher was particularly effective for degreasing within the kitchen ventilation system 100. The operating setpoint may be set as a minimum threshold, whereby subsystems of the kitchen ventilation system 100 are controlled to maintain at least the minimum temperature threshold. For example, the temperature control subsystem can be controlled based on a sensed temperature within the kitchen ventilation system 100 to maintain the temperature setpoint. In some embodiments, the temperature within the kitchen ventilation system 100 can also be cooled to cool oil and grease. This ensures a temperature that is effective for the hydrolytic action of the enzymes and bacteria of the degreasing agent. The degreasing controller module 128 can be configured to operate the temperature control subsystem to obtain the temperature setpoint within the kitchen ventilation system.

According to another example application, the operating setpoint is a level of humidity within the kitchen ventilation system. The rinsing may be carried out during a post-injection subinterval can last from several minutes to several hours.

According to another example application, the operating setpoint is an amount and duration of water for rinsing the kitchen ventilation system. The rinsing can be carried out during a post-injection subinterval for a duration of at least 4 hours.

According to another example application, the airflow in the kitchen ventilation system 100 can be adjusted based on the temperature in the system to improve dispersion of the degreasing agent.

According to various example embodiments, the method and system for degreasing the kitchen ventilation system 100 includes sensing at least one operating condition within the kitchen ventilation system 100. A set of one or more degreasing parameters is further determined based on the sensed at least one operating condition and/or operating state. Accordingly, the kitchen ventilation system includes at least one ventilation condition sensor that is operable to sense at least one operating condition within the kitchen ventilation system.

The ventilation condition sensor 132 is operatively connected to the degreasing control module to transmit the at least one operating condition to the degreasing controller module. The degreasing controller module 128 can be configured to determine the degreasing parameters based on the operating condition within the kitchen ventilation system and then, sends control signals to operate the degreasing agent injection subsystem 108 and/or the ventilation controller 116.

The degreasing agent injection subsystem 108 is further operated to inject at least one degreasing agent within the kitchen ventilation system 100 according to the set of one or more degreasing parameters. The degreasing controller module 128 can also be configured to operate the degreasing agent injection subsystem to inject the degreasing agent into the duct subsystem according to the set of one or more degreasing parameters.

The set of degreasing parameters includes one or more of scheduling parameter, agent type parameter and agent volume parameter. The scheduling parameter defines when degreasing should be carried out (ex: start time of a degreasing interval). The agent type parameter defines the type or types of degreasing agent that are to be injected within the kitchen ventilation system 100. The agent volume parameter defines the volume of each type of degreasing agent to be injected. The set of degreasing parameters can also include one or more operating setpoints defining the operation of subsystems of the kitchen ventilation system 100 during a degreasing interval defined by the degreasing parameters.

The sensed operating conditions includes one or more of a current temperature within the kitchen ventilation system 100, a type of emissions received within the kitchen ventilation system 100, and a quantity of emissions received within the kitchen ventilation system 100. The type and quantity of emissions can provide an indication of the type of cooking being carried out (ex: cooking that has a lot of vapor, grease, or smoke) and the intensity of grease buildup that will result from the cooking.

According to one example embodiment, and as illustrated, the ventilation condition sensor 132 includes one or more optical sensors 140 that are configured to capture visual data that is indicative of the type and/or quantity of emissions. For example, the optical sensors 140 can capture visual properties of the emissions (ex: vapor/smoke) flowing from the cooktop into the duct subsystem 16 and determine indicators of the type and/or quantity of the emissions from the visual properties.

The ventilation condition sensor 132 may include a grease sensor that may be positioned in the range hood 12 and/or duct subsystem 16 to detect a level or thickness of grease build-up.

The sensed operating states can include one or more of degree of openness of the damper 124 and the speed of the airflow subsystem.

The set of one or more degreasing parameters are determined based on the sensed at least one operating condition and/or operating state so that degreasing is carried out according to the requirement for degreasing caused by cooking emissions.

Alternatively, or additionally, the set of degreasing parameters is determined according to when operating conditions favourable to degreasing are present.

The set of degreasing parameters can include one or more degreasing setpoints that define how the kitchen ventilation system is to be operated during a degreasing time interval.

In one example embodiment, the at least one operating condition is monitored in real-time. Where it is determined that the emissions within the kitchen ventilation are sufficiently high such that degreasing is required, the set of degreasing parameters can be determined in real-time, such as by the degreasing controller module 128, and the injection of the degreasing agent can be started. Degreasing setpoints to be maintained during the degreasing interval can also be determined.

The determination of the set of degreasing parameters can include adjusting the set of degreasing parameters when degreasing is ongoing. For example, while degreasing is carried out during operating of the kitchen ventilation system 100, the at least one operating condition is monitored in real-time and the set of degreasing parameters is adjusted accordingly in real-time. This may include decreasing or increasing the volume of degreasing agent that is injected based on decrease or increase in emissions as sensed by the optical sensors 140 of the ventilation condition sensor 132. This may also include varying the type of degreasing agent to be injected.

In one example embodiment, the at least one operating condition within the kitchen ventilation system 100 is tracked over an extended interval of time, referred to herein as a “tracking interval of time”. This interval of time may be on the order of several hours to several days. The tracking provides historical data of the operating conditions. The set of degreasing parameters is then determined based on the historical data of operating conditions sensed during this interval of time. For example, the historical data of operating conditions can be analyzed to assess degreasing needs and the set of degreasing parameters are determined to address the degreasing needs.

According to one example embodiment, the historical data of operating conditions tracked over the tracking interval of time is analyzed to identify patterns within past operation of the kitchen ventilation system 100 that is indicative of how the kitchen ventilation system 100 will be operated in the future.

The historical data can be analyzed to identify particular time intervals (ex: particular intervals of the day, particular days of the week) during which there is a need for degreasing (ex: due to high levels of emissions from the cooktop). The set of degreasing parameters is then determined so that degreasing time intervals are scheduled for these same particular time intervals for future operation of the kitchen ventilation system 100.

The historical data can be analyzed to identify particular time intervals (ex: particular intervals of the day, particular days of the week) during which operating conditions within the kitchen ventilation system 100 and/operating states of the kitchen ventilation system 100 that were favourable to degreasing were present. Such intervals are herein referred to as “degreasing-effective time intervals”. The set of degreasing parameters is then determined so that degreasing time intervals are scheduled for these same particular time intervals for future operation of the kitchen ventilation system 100.

The tracking of operating conditions within the kitchen ventilation system can be carried out for a “tracking interval of time” that has a duration that is greater than or equal to a week. It was observed that cooking operations within a kitchen typically have a repeated weekly pattern. The operating conditions present over the course of a week will likely be repeated within subsequent weeks. Accordingly, a pattern identified from tracking operating conditions over the course of a week or more can be used to determine degreasing parameters that define the scheduling of degreasing time intervals on a weekly basis.

In one example embodiment, the historical data can be analyzed to identify time intervals during which the temperature within the kitchen ventilation system 100 exceed a temperature threshold (ex: 33 degrees Celsius) that is favourable for degreasing.

In one example embodiment, the historical data can be analyzed to identify intervals during which the fan speed is sufficiently high. As described elsewhere, injecting the degreasing agent while the fan speed is sufficiently high can be effective for dispersing the degreasing agent within the duct subsystem 16.

More specifically, determining when the fan speed is greater than the third speed described herein can be used to determine when injecting will be effective for dispersing greasing agent at the exhaust region 138 of the duct subsystem. A time interval within the tracked data of operating conditions during which the fan speed is greater than the third speed and the operating temperature within the system is greater than a predetermined temperature threshold (ex: 33 degrees Celsius) can be identified as a degreasing-effective time interval. The degreasing parameters can be defined so that injection of degreasing agent is scheduled for a future degreasing time interval corresponding to this identified degreasing-effective time interval (ex: the same intervals of the day, and same days of the week in the future).

Determining when the fan speed operating is between the second speed and the third speed described herein can be used to determine when injection will be effective for dispersing greasing agent at the conduit region 136 of the duct subsystem 16. A time interval within the tracked data of operating conditions during which the fan speed is between the second speed and the third speed and the operating temperature within the system is greater than a predetermined temperature threshold (ex: 33 degrees Celsius) can be identified as a degreasing-effective sub-interval of time. The degreasing parameters can be defined so that injection of degreasing agent is scheduled for a future degreasing time interval corresponding to this identified degreasing-effective time interval (ex: the same intervals of the day, and same days of the week in the future).

In one example embodiment, the historical data includes data indicating the speed of the airflow subsystem of the kitchen ventilation system that has been tracked and a presence of cooking emissions received within the kitchen ventilation system that has been tracked. More particularly, it is identified within these tracked operating conditions at least one interval of time during which the airflow subsystem of the kitchen ventilation system is operating at the first speed described herein (low speed or off speed) and in which there is a non-presence of cooking emissions (i.e. no cooking emissions are present). It will be appreciated that operating the airflow speed at the first speed is effective for dispersing degreasing agent at the inlet region 134 of the duct subsystem 16. Furthermore, subsequent to injecting the degreasing agent, the first speed should be maintained for a sufficiently long duration of time to allow the degreasing agent to act the inlet region 134. Upon identifying a degreasing-effective time interval having the sufficiently long duration and in which these operating conditions are present, degreasing parameters can be defined so that injection of degreasing agent is scheduled for a future degreasing time interval corresponding to this identified degreasing-effective time interval (ex: the same intervals of the day, and same days of the week in the future). As described elsewhere herein, the duration of the time interval in which these operating conditions are present should be at least 4 hours and a time interval having these operating conditions and lasting greater than 4 hours is identified as a degreasing-effective sub-interval.

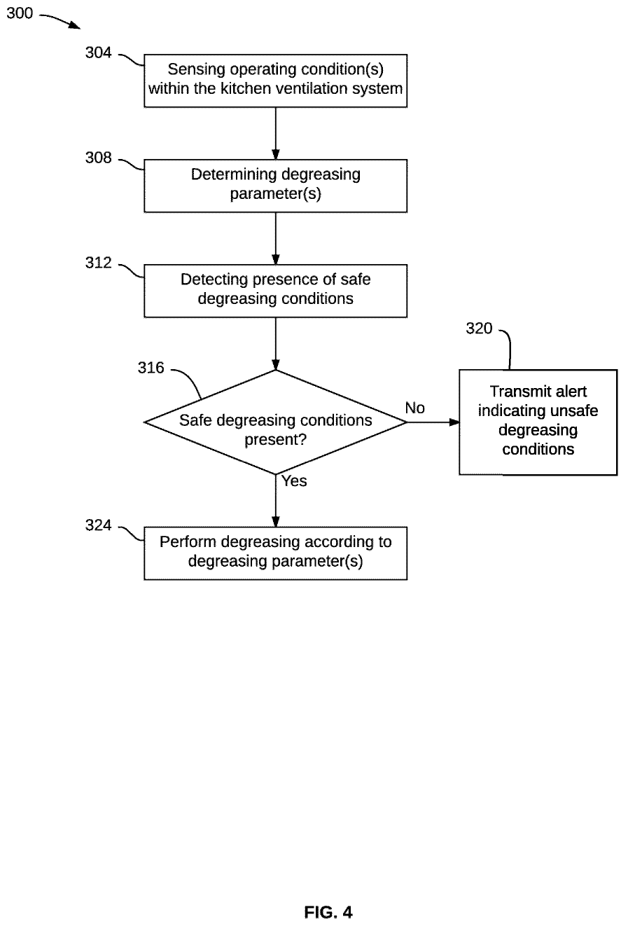

Referring now to FIG. 4, therein illustrated is a flowchart of the operational steps of a method 300 for carrying out degreasing of a kitchen ventilation system 100 according to an example embodiment.

At step 304, at least one operating condition within the kitchen ventilation is sensed. As described elsewhere herein, the sensing of the operating condition can include monitoring at least one operating condition in real-time. The sensing of the operating condition can also include tracking one or more operating conditions over an extended interval of time, which will allow generating historical data of tracked operating condition(s). The operating condition can be sensed by the condition sensor subsystem 132.

At step 308, the set of at least one degreasing parameter is determined. As described elsewhere herein, the determining of set of the degreasing parameter can include adjusting the set of degreasing parameters while degreasing is ongoing. The determining of the set of the degreasing parameter can be carried out based on the historical data of operating conditions sensed. The at least one degreasing parameter can be determined at the degreasing controller module 128. The degreasing controller module 128 can receive the operating condition sensed by the condition sensor subsystem 132.

At step 312, prior to carrying out a degreasing action that includes injection of the degreasing agent, it is determined whether safe degreasing conditions are present.

It was observed that contact of the degreasing agent with heated substances (ex: food or oil being cooked beneath the kitchen ventilation system 100) can present a hazard for a person in the kitchen. For example, the degreasing agent can be flammable when heated, which presents a burn risk. Accordingly, in one example embodiment, a safe degreasing condition includes the presence of a filter 24 being installed at the inlet of the duct subsystem 16. The filter 24 captures degreasing agent injected into the duct subsystem 16 and is particularly effective in restricting the injected degreasing agent from reaching heated substances located below the kitchen ventilation system 100.

It was further observed that the filter 24 is often removed subsequent to a cooking operation for cleaning. Therefore, the filter 24 not being present at the inlet presents a real risk to a human operator.

At step 316, it is determined whether safe degreasing conditions are present. If safe degreasing conditions are not present, the method 300 proceeds to step 320 to transmit an alert indicating the presence of unsafe degreasing conditions. The alert can be audible or visual alert that is perceptible to a human operator.

If safe degreasing conditions are present, the method 300 proceeds to step 324 to perform a degreasing operation in accordance with the set of degreasing parameters determined at step 308. For example, a degreasing cycle as described herein with reference to FIG. 3 can be carried out. The degreasing controller module 128 can send appropriate control signals to the degreasing agent injection subsystem 108 and/or the kitchen ventilation controller 116 to cause the degreasing operation to be performed. Where the degreasing controller module 128 controls degreasing agent injection subsystem 108 and/or the kitchen ventilation controller 116 to maintain one or more degreasing setpoints, the degreasing controller module 128 can further receive from the condition sensor subsystem 132 one or more conditions sensed within the kitchen ventilation system 100.

The degreasing controller module 128 can be configured (ex: appropriately programmed) to operate various subsystems of the kitchen ventilation system to carry out the steps of method 300.

More particularly, in one example embodiment, the degreasing controller module 128 receives tracked operating conditions that include a speed of the air flow subsystem and a presence of cooking emissions received within the duct subsystem. The degreasing controller module 128 is further configured to determine the set of one or more degreasing parameters by identifying within the tracked operating conditions at least one degreasing-effective time interval during which the airflow subsystem is operating at a substantially low speed or is turned off and there is a non-presence of cooking emissions and defining degreasing parameters to schedule carrying out degreasing effective for degreasing an inlet region of the duct subsystem during a future degreasing time interval corresponding to the identified degreasing-effective time interval (ex: the same intervals of the day, and same days of the week in the future). The degreasing controller module 128 can be further configured to identify the degreasing-effective time interval by identifying, within the tracked operating conditions, one or more time intervals each having a duration greater than four hours as effective for degreasing the inlet region of the duct subsystem.

Additionally or alternatively, the at least one tracked operating condition comprises a speed of the airflow subsystem of the kitchen ventilation system and a temperature within the kitchen ventilation system. The degreasing controller module 128 is further configured to determine the set of one or more degreasing parameters by identifying within the tracked operating conditions at least one degreasing-effective time interval during which the airflow subsystem is operating at a substantially high speed and the temperature is greater than a predetermined temperature threshold and defining degreasing parameters to schedule carrying out degreasing effective for degreasing a region of the duct subsystem downstream of an inlet region during a future degreasing time interval corresponding to the identified degreasing-effective time interval (ex: the same intervals of the day, and same days of the week in the future).

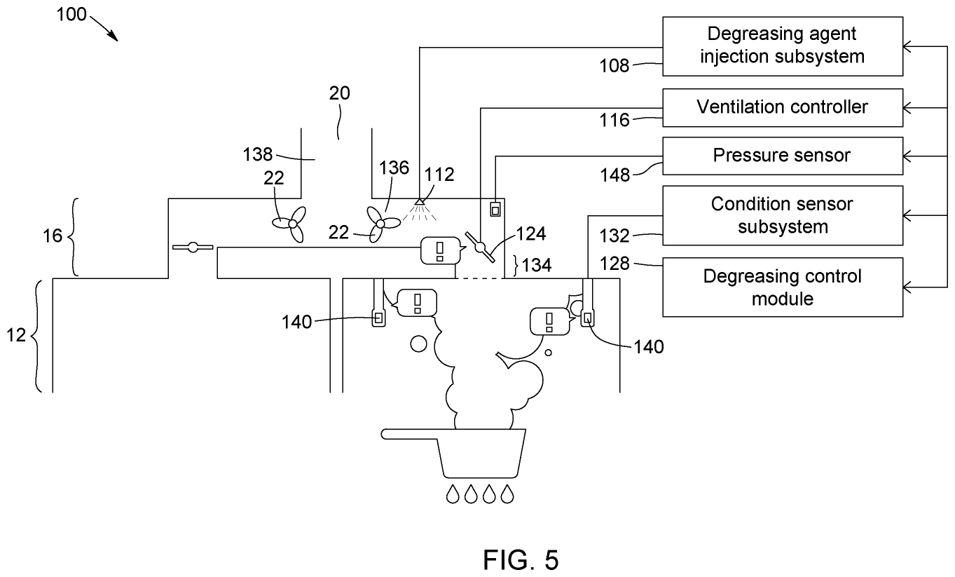

Referring now to FIG. 5, therein illustrated is a schematic diagram of a degreasing-capable kitchen ventilation system 100′ according to an alternative embodiment that includes a filter detection subsystem 148 operable for detecting a condition related to the presence of the filter at the inlet. The filter detection subsystem 148 is operatively connected to the degreasing controller module 128 and is operable to output a signal to the degreasing controller module 128 indicating the condition related to the presence or non-presence of the filter at the inlet. The degreasing controller module 128 is configured to detect a presence of safe degreasing conditions from detecting the presence of a filter at the inlet of the duct subsystem based on the detected condition received from the filter detection subsystem. The degreasing controller module 128 is further configured to control the decreasing agent injection subsystem 108 to inject the degreasing agent only when a signal is received from the sensor 148 indicating that a filter is present at the inlet 134. That is, the degreasing controller module 128 is configured to prevent the operating of the degreasing agent injection subsystem from inject the degreasing agent into the duct subsystem unless a presence of safe degreasing conditions is detected.

In one example embodiment, the filter detection subsystem 148 is an occupancy sensor positioned at or in proximity of the inlet 134 of the duct subsystem 16. The occupancy sensor can be any one of a magnetic sensor, mechanical switch, or optical sensor.

According to another example embodiment, the filter detection subsystem 148 includes one or more pressure sensor positioned in the duct subsystem 16 that is operable to sense the variation of air pressure within the duct subsystem 16. The pressure sensor can be part of the airflow subsystem and may be otherwise used to measure the current airflow through the duct subsystem 16 (an operating condition).

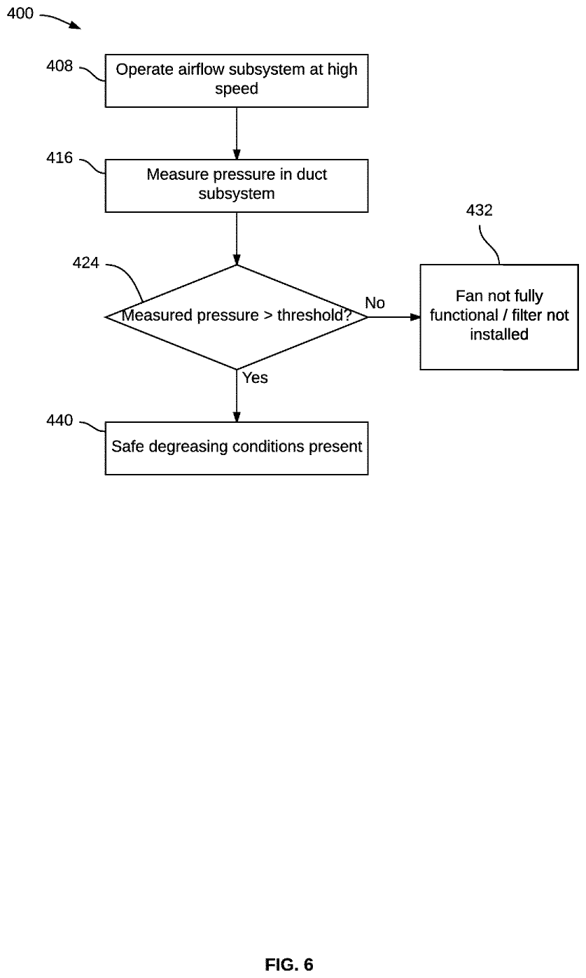

Referring now to FIG. 6, therein illustrated is a flowchart of the operational steps of a method 400 for detecting the presence of the filter 24 at the inlet of the duct subsystem 16 according to an example embodiment. The method 400 makes use of the airflow subsystem and the pressure sensor 148.

At step 408, the airflow subsystem of the kitchen ventilation system is operated at a substantially high speed. The speed of the kitchen ventilation system at step 408 is sufficiently high so that the airflow generated at this speed is greater than any airflow that would naturally occur when the kitchen ventilation system is not operating, such as from a natural draft flowing through the duct subsystem 16. For example, the airflow subsystem can be operated at its maximum speed.

At step 416, the variation of air pressure within the duct subsystem 16 is measured using pressure sensors 148 while the airflow subsystem is operated at the substantially high speed.

At step 424, it is determined whether the measured air pressure variation exceeds a pressure variation threshold. It was observed that the measured air pressure variation within the duct subsystem 16 while operating the airflow subsystem varied substantially between whether the filter is present at the inlet versus when the filter is not present at the inlet. Accordingly, the threshold of pressure variation, which can be predetermined, is chosen that allows distinguishing between whether the filter is present or not. Step 424 can be equivalent to step 316 of method 300.

If the measured pressure variation does not exceed the pressure variation threshold, the method 424 proceeds to step 432 to indicate that unsafe degreasing conditions are present. This may correspond to a situation where either the airflow subsystem is not fully functional or a situation where the filter is not present at the inlet of the duct subsystem 16. Step 432 can be equivalent to step 320 of method 300.

If the measured does exceed the pressure variation threshold, the method 424 proceeds to step 440 to indicate that safe degreasing conditions are present. It will be appreciated that the threshold is exceeded only if both the airflow subsystem is operating properly at the substantially high speed and the filter is present at the inlet. According taking the measurement of the air pressure variation with the duct subsystem 16 serves the dual purpose of detecting the presence of the filter at the inlet and detecting that the airflow subsystem is operating properly.

As described with reference to FIG. 4, subsequent to detecting that safe degreasing conditions are present, the injection of the degreasing agent can be carried out.

The degreasing controller module 128 can be configured (ex: appropriately programmed) to operate various subsystems of the kitchen ventilation system to carry out the steps of method 400.

More particularly, according to one example embodiment, the degreasing controller 128 is configured for detecting the operating the airflow subsystem of the kitchen ventilation system at a substantially high speed, measuring the air pressure variation within the duct subsystem of the kitchen ventilation system while operating the airflow subsystem at the substantially high speed, and detecting the presence of the filter if the measured air pressure variation exceeds an air pressure variation threshold. The degreasing controller module 128 is also configured to determine an operational state of the airflow subsystem from the measured air pressure variation exceeding the air pressure variation threshold.

Advantageously, the methods and systems for degreasing the kitchen ventilation system 100 described herein according to various example embodiments can provide for effective degreasing of the kitchen ventilation system 100 by ensuring that the operating conditions favorable for degreasing are maintained. This may be achieved by controlling operating states of subsystems of the kitchen ventilation system 100 to maintain the favourable operating conditions. This may also be achieved by identifying when such favourable operating conditions are present within the kitchen ventilation system 100 and setting degreasing parameters so that the degreasing is carried out during such intervals when such favourable operating conditions are present.

The methods and systems for degreasing the kitchen ventilation system 100 described herein according to various example embodiments also provide more efficient degreasing of the kitchen ventilation system 100. By monitoring the volume and/or type of cooking emissions received within the kitchen ventilation system 100, the set of degreasing parameters can be determined so that the type of degreasing agent and/or a volume of degreasing agent that is suitable for the degreasing that is required is used. This can reduce wasteful use of degreasing agent from unnecessary injection or improper injection of degreasing agent.

The methods and systems for degreasing the kitchen ventilation system 100 described herein according to various example embodiments can further provide energy savings. By tracking the operating conditions in the kitchen ventilation system 100 over time, identifying intervals of time in which operating conditions favourable to degreasing agent are present, and scheduling future degreasing instances to concord to such intervals of time, the degreasing is carried out while the kitchen ventilation system 100 is currently operating. This decreases instances where the kitchen ventilation system 100 is operated (ex: turning on the airflow subsystem) solely for degreasing, thereby further result in some energy savings.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A method for degreasing a kitchen ventilation system, the method comprising:
determining at least one degreasing setpoint for a degreasing time interval;
injecting at least one degreasing agent within the kitchen ventilation system during at least a portion of the degreasing time interval; and
operating at least one subsystem of the kitchen ventilation system in accordance with the at least one degreasing setpoint during the degreasing time interval.

2. The method of claim 1, wherein operating the at least one subsystem of the kitchen ventilation system in accordance with the at least one degreasing setpoint comprises controlling at least one subsystem of the kitchen ventilation system to maintain the degreasing setpoint during the degreasing time interval.

3. The method of claim 1 or 2, wherein the kitchen ventilation system comprises a duct subsystem;
wherein injecting at least one degreasing agent within the kitchen ventilation system comprises injecting the at least one degreasing agent into the duct subsystem of the kitchen ventilation system;
wherein the at least one degreasing setpoint comprises a first speed of an airflow subsystem of the kitchen ventilation system and a second speed of the airflow subsystem of the kitchen ventilation system; and
wherein operating the at least one subsystem of the kitchen ventilation system comprises:
operating the airflow subsystem at the first speed while injecting the degreasing agent during a first portion of the degreasing time interval; and
operating the airflow subsystem at the second speed while injecting the degreasing agent during a second portion of the degreasing time interval.

4. The method of claim 3, wherein the second speed of the airflow subsystem of the kitchen ventilation system is greater than the first speed of the airflow subsystem.

5. The method of claim 4, wherein operating the airflow subsystem of the kitchen ventilation system at the first speed while injecting the degreasing agent is effective for providing degreasing action at an inlet region of the duct subsystem.

6. The method of claim 4 or 5, wherein the first speed is a low speed or an off state of the airflow subsystem of the kitchen ventilation system.

7. The method of any one of claims 3 to 6, wherein the airflow subsystem is operated at the first speed for a post-injection time subinterval of the degreasing time interval, the post-injection time subinterval corresponding to an interval of time after completion of the injecting of the at least one degreasing agent.

8. The method of claim 7, wherein the post-injection time interval has a duration greater than four hours.

9. The method of any one of claims 3 to 8, wherein operating the airflow subsystem of the kitchen ventilation system at the second speed while injecting the degreasing agent is effective for providing degreasing action to a portion of duct subsystem downstream of the inlet region.

10. The method of claim 9, wherein the at least one degreasing setpoint comprises a third speed of the airflow subsystem of the kitchen ventilation system, the third speed being greater than the first speed and the second speed;
wherein operating the at least one subsystem of the kitchen ventilation system comprises operating the airflow subsystem at the third speed while injecting the degreasing agent during a third portion of the degreasing time interval; and
wherein operating the airflow subsystem of the kitchen ventilation system at the second speed while injecting the degreasing agent is effective for providing degreasing action at a conduit region of the duct subsystem of the kitchen ventilation system;
wherein operating the airflow subsystem of the kitchen ventilation system at the third speed while injecting the degreasing agent is effective for providing degreasing action at an exhaust region of the duct subsystem of the kitchen ventilation system.

11. The method of any one of claims 1 to 10, wherein the at least one degreasing setpoint comprises a temperature setpoint of the kitchen ventilation system; and
wherein operating the at least one subsystem of the kitchen ventilation system comprises operating a temperature control subsystem to substantially maintain the temperature setpoint within the kitchen ventilation system during the degreasing time interval.

12. The method of claim 11, wherein the temperature control subsystem is operated to substantially maintain the temperature setpoint for a post-injection time subinterval of the degreasing time interval, the post-injection time subinterval corresponding to an interval of time after completion of the injecting of the at least one degreasing agent.

13. The method of claim 11 or 12, wherein the temperature setpoint is a temperature of approximately 33 degrees Celsius or greater.

14. The method of any one of claims 1 to 13, further comprising determining the at least one degreasing setpoint in accordance with a preconfigured degreasing program.

15. The method of any one of claims 1 to 13, further comprising sensing at least one operating condition within the kitchen ventilation system and wherein the at least one degreasing setpoint is determined based on the sensed at least one operating condition within the kitchen ventilation system.

16. The method of claim 15, wherein the sensed at least one operating condition comprises at least one of a type of cooking emissions received within the kitchen ventilation system and a quantity of cooking emissions received within the kitchen ventilation system.

17. The method of claim 16, wherein sensing the at least one of the type of cooking emissions received within the kitchen ventilation system and the quantity of cooking emissions received within the kitchen ventilation system is carried out using one or more optical sensors.

18. The method of any one of claims 1 to 17, further comprising detecting a presence of safe degreasing conditions prior to injecting the at least one degreasing agent, the detecting comprising detecting the presence of a filter at an inlet of a duct subsystem of the kitchen ventilation system.

19. The method of claim 18, wherein detecting the presence of the filter comprises receiving a signal from an occupancy sensor positioned at the inlet of the duct subsystem.

20. The method of claim 18, wherein detecting the presence of the filter comprises:
operating an airflow subsystem of the kitchen ventilation system at a substantially high speed;
measuring an air pressure variation within the duct subsystem of the kitchen ventilation system while operating the airflow subsystem at the substantially high speed;
detecting the presence of the filter if the measured air pressure variation exceeds an air pressure variation threshold.

21. The method of claim 20, wherein determining the measured air pressure variation exceeding the air pressure variation threshold is further indicative of an operational state of the airflow subsystem.

22. The method according to any one of claims 1 to 21, wherein the degreasing agent is a biological degreasing agent comprising at least one of bacteria and enzymes.

23. A method for degreasing a kitchen ventilation system, the method comprising:
sensing at least one operating condition within the kitchen ventilation system;
determining a set of one or more degreasing parameters based on the at least one sensed operating condition; and
injecting at least one degreasing agent within the kitchen ventilation system according to the set of one or more degreasing parameters.

24. The method of claim 23, wherein the sensed at least one operating condition comprises at least one of a type of cooking emissions received within the kitchen ventilation system and a quantity of cooking emissions received within the kitchen ventilation system.

25. The method of claim 24, wherein sensing the at least one of the type of emissions received within the kitchen ventilation system and the quantity of emissions received within the kitchen ventilation system is carried out using one or more optical sensors.

26. The method of claim 24 or 25, wherein the one or more degreasing parameters comprises at least one of an amount of the degreasing agent to be injected and the type of the degreasing agent to be injected.

27. The method of any one of claims 23 to 26, wherein the sensing at least one operating condition within the kitchen ventilation system comprises tracking the operating condition over a tracking interval of time.

28. The method of claim 27, wherein a duration of the tracking interval of time for carrying out the tracking of the operating condition is greater than a week.

29. The method of claim 27 or 28, wherein the kitchen ventilation system comprises an airflow subsystem and a duct subsystem;
wherein the at least one tracked operating condition comprises a speed of the airflow subsystem and a presence of cooking emissions received within the duct subsystem; and
wherein determining the set of one or more degreasing parameters comprises:
identifying within the tracked operating conditions at least one degreasing-effective time interval during which the airflow subsystem is operating at a substantially low speed or is turned off and there is a non-presence of cooking emissions; and
defining degreasing parameters to schedule carrying out degreasing effective for degreasing an inlet region of the duct subsystem during a future degreasing time interval corresponding to the identified degreasing-effective time interval.

30. The method of claim 29, wherein the identifying the degreasing-effective time interval comprises identifying, within the tracked operating conditions, one or more time intervals each having a duration greater than four hours as effective for degreasing the inlet region of the duct subsystem.

31. The method of any one of claims 27 to 30, wherein the at least one tracked operating condition comprises a speed of an airflow subsystem of the kitchen ventilation system and a temperature within the kitchen ventilation system; and
wherein determining the set of one or more degreasing parameters comprises:
identifying within the tracked operating conditions at least one degreasing-effective time interval during which the airflow subsystem is operating at a substantially high speed and the temperature is greater than a predetermined temperature threshold; and
defining degreasing parameters to schedule carrying out degreasing effective for degreasing a region of the duct subsystem downstream of an inlet region during a future degreasing time interval corresponding to the identified degreasing-effective time interval.

32. The method of any one of claims 23 to 31, further comprising detecting a presence of safe degreasing conditions prior to injecting the at least one degreasing agent, the detecting comprising detecting the presence of a filter at an inlet of a duct subsystem of the kitchen ventilation system.

33. The method of claim 32, wherein detecting the presence of the filter comprises receiving a reading from an occupancy sensor positioned at the inlet of the duct subsystem.

34. The method of claim 32, wherein detecting the presence of the filter comprises:
operating an airflow subsystem of the kitchen ventilation system at a substantially high speed;
measuring an air pressure variation within a duct subsystem of the kitchen ventilation system while operating the airflow subsystem at the substantially high speed;
detecting the presence of the filter if the measured air pressure variation exceeds an air pressure variation threshold.

35. The method of claim 34, wherein determining the measured air pressure variation exceeding the air pressure variation threshold is further indicative of an operational state of the airflow subsystem.

36. The method according to any one of claims 23 to 35, wherein the degreasing agent is a biological degreasing agent comprising at least one of bacteria and enzymes.

37. A method for degreasing a kitchen ventilation system having an airflow subsystem and a duct subsystem, the method comprising:
detecting within the kitchen ventilation system a presence of safe degreasing conditions, the detecting comprising detecting the presence of a filter at an inlet of the duct subsystem; and
subsequent to detecting the presence of the safe degreasing conditions, injecting at least one degreasing agent within the duct subsystem during at least a portion of a degreasing time interval.

38. The method of claim 37, wherein detecting the presence of the filter comprises receiving a signal from an occupancy sensor positioned at the inlet of the duct subsystem.

39. The method of claim 37, wherein detecting the presence of the filter comprises:
operating the airflow subsystem at a substantially high speed;
measuring an air pressure variation within the duct subsystem of the kitchen ventilation system while operating the airflow subsystem at the substantially high speed;
detecting the presence of the filter if the measured air pressure variation exceeds an air pressure variation threshold.

40. The method of claim 39, wherein determining the measured air pressure variation exceeding the air pressure variation threshold is further indicative of an operational state of the airflow subsystem.

41. The method according to any one of claims 37 to 40, wherein the degreasing agent is a biological degreasing agent comprising at least one of bacteria and enzymes.

42. A degreasing-enabled kitchen ventilation system, the ventilation system comprising:
a plurality of subsystems of the kitchen ventilation system, including a duct subsystem and a degreasing agent injection subsystem, the degreasing agent injection subsystem including a degreasing agent supply in fluid communication with the duct subsystem and operable for selectively injecting at least one degreasing agent contained in the degreasing agent supply into the duct subsystem;
a degreasing controller module operatively connected to the degreasing agent injection subsystem and at least one other of the plurality of subsystems of the kitchen ventilation system, the degreasing controller module being configured for:
determining at least one degreasing setpoint;
operating the at least one other of the plurality of subsystems of the kitchen ventilation system in accordance with the at least one degreasing setpoint; and
operating the degreasing agent injection subsystem to inject the degreasing agent into the duct subsystem.

43. The kitchen ventilation system of claim 42, wherein the degreasing agent injection subsystem comprises a degreasing agent flow control member operatively connected to the degreasing controller module and mounted in a degreasing flow path between the degreasing agent supply and the duct subsystem, the degreasing agent flow control member being selectively configurable between a closed configuration and at least one open configuration to control the injection of the degreasing agent into the duct subsystem.

44. The kitchen ventilation system of claim 42 or 43, wherein the degreasing controller module is configured for:
defining a degreasing time interval;
operating the degreasing agent injection subsystem to inject the degreasing agent into the duct subsystem during the degreasing time interval; and
operating the at least one other of the plurality of subsystems of the kitchen ventilation system in accordance with the at least one degreasing setpoint during the degreasing time interval.

45. The kitchen ventilation system of any one of claims 42 to 44, wherein the plurality of subsystem of the kitchen ventilation system further comprises an airflow subsystem being operatively connected to and controllable by the degreasing controller module and being operable to cause airflow through the duct subsystem.

46. The kitchen ventilation system of claim 45, wherein the degreasing controller module is configured to determine the at least one degreasing setpoint by determining a first speed of the airflow subsystem of the kitchen ventilation system and a second speed of the airflow subsystem of the kitchen ventilation system; and wherein the degreasing controller module is configured for:
operating the airflow subsystem at the first speed while injecting the degreasing agent during a first portion of the degreasing time interval; and
operating the airflow subsystem at the second speed while injecting the degreasing agent during a second portion of the degreasing time interval.

47. The kitchen ventilation system of claim 46, wherein the second speed of the airflow subsystem of the kitchen ventilation system is greater than the first speed of the airflow subsystem.

48. The kitchen ventilation system of claim 47, wherein operating the airflow subsystem of the kitchen ventilation system at the first speed while injecting the degreasing agent is effective for providing degreasing action at an inlet region of the duct subsystem.

49. The kitchen ventilation system of claim 47 or 48, wherein the first speed is a low speed or an off state of the airflow subsystem of the kitchen ventilation system.

50. The kitchen ventilation system of any one of claims 46 to 49, wherein the degreasing controller module is configured for:
operating the airflow subsystem at the first speed for a post-injection time subinterval of the degreasing time interval, the post-injection time subinterval corresponding to an interval of time after completion of the injecting of the at least one degreasing agent.

51. The kitchen ventilation system of claim 50, wherein the post-injection time interval has a duration greater than four hours.

52. The kitchen ventilation system of any one of claims 46 to 51, wherein operating the airflow subsystem of the kitchen ventilation system at the second speed while injecting the degreasing agent is effective for providing degreasing action to a portion of duct subsystem downstream of the inlet region.

53. The kitchen ventilation system of claim 52, wherein the at least one degreasing setpoint comprises a third speed of the airflow subsystem of the kitchen ventilation system, the third speed being greater than the first speed and the second speed;
wherein the degreasing controller module is configured for operating the airflow subsystem at the third speed while injecting the degreasing agent during a third portion of the degreasing time interval; and
wherein operating the airflow subsystem of the kitchen ventilation system at the second speed while injecting the degreasing agent is effective for providing degreasing action at a conduit region of the duct subsystem of the kitchen ventilation system;
wherein operating the airflow subsystem of the kitchen ventilation system at the third speed while injecting the degreasing agent is effective for providing degreasing action at an exhaust region of the duct subsystem of the kitchen ventilation system.

54. The kitchen ventilation system of any one of claims 42 to 53, wherein the plurality of subsystems of the kitchen ventilation system comprises a temperature control subsystem being operatively connected to and controllable by the degreasing controller module;
wherein the degreasing controller module is configured to determine the at least one degreasing setpoint by determining a temperature setpoint of the kitchen ventilation system; and
wherein the degreasing controller is configured to operate the at least one other of the plurality of subsystems of the kitchen ventilation system by operating the temperature control subsystem to obtain the temperature setpoint within the kitchen ventilation system.

55. The kitchen ventilation system of claim 54, wherein the temperature setpoint is a temperature of approximately 33 degrees Celsius or greater.

56. The kitchen ventilation system of any one of claims 42 to 55, wherein the degreasing controller module is configured to determine the at least one degreasing setpoint according to a preconfigured degreasing program.

57. The kitchen ventilation system of any one of claims 42 to 55, further comprising at least one ventilation condition sensor operable to sense at least one operating condition within the kitchen ventilation system, the at least one ventilation condition sensor being operatively connected to the degreasing controller module to transmit the at least one ventilation condition to the degreasing controller module; and
wherein the degreasing controller module is configured to determine the at least one degreasing setpoint based on the operating condition within the kitchen ventilation system.

58. The kitchen ventilation system of claim 57, wherein the sensed at least one operating condition comprises at least one of a type of cooking emissions received within the kitchen ventilation system and a quantity of cooking emissions received within the kitchen ventilation system.

59. The kitchen ventilation system of claim 58, wherein the sensed at least one operating condition comprises at least one of a type of cooking emissions received within the kitchen ventilation system and a quantity of cooking emissions received within the kitchen ventilation system.

60. The kitchen ventilation system of any one of claims 42 to 59, wherein the at least one subsystem of the kitchen ventilation system comprises a filter detection subsystem operatively connected to the degreasing controller module and being operable to transmit a detected condition related to a presence of a filter at an inlet of the duct subsystem to the degreasing controller module; and
wherein the degreasing controller is further configured for:
detecting a presence of safe degreasing conditions from detecting the presence of the filter at the inlet of the duct subsystem of the kitchen ventilation system based on the transmitted detected condition.

61. The kitchen ventilation system of claim 60, wherein the degreasing controller is configured for preventing the operating of the degreasing agent injection subsystem to inject the degreasing agent into the duct subsystem unless a presence of safe degreasing conditions is detected.

62. The kitchen ventilation system of claim 60, wherein the filter detection subsystem comprises an occupancy sensor positioned at the inlet of the duct subsystem being operable to detect the presence of the filter.

63. The kitchen ventilation system of claim 60, wherein the plurality of subsystems of the kitchen ventilation system comprises an airflow subsystem being operatively connected to and controllable by the degreasing controller module and being operable to cause airflow through the duct subsystem; and
wherein the filter detection subsystem comprises an air pressure sensor operable to measure an air pressure variation within the duct subsystem, the air pressure variation being the detected condition; and
wherein the degreasing controller is configured for detecting the presence of the filter by:
operating the airflow subsystem of the kitchen ventilation system at a substantially high speed;
measuring the pressure variation within the duct subsystem of the kitchen ventilation system while operating the airflow subsystem at the substantially high speed;
detecting the presence of the filter if the measured air pressure variation exceeds an air pressure variation threshold.

64. The kitchen ventilation system of claim 63, wherein the degreasing controller is configured for also determining an operational state of the airflow subsystem from the measured air pressure variation exceeding the air pressure variation threshold.

65. The kitchen ventilation system of any one of claims 42 to 64, wherein the degreasing agent is a biological degreasing agent comprising at least one of bacteria and enzymes.

66. A degreasing-enabled kitchen ventilation system comprising:
at least one condition sensor configured for sensing at least one operating condition within the kitchen ventilation system; and
a plurality of subsystems of the kitchen ventilation system, including a duct subsystem and a degreasing agent injection subsystem, the degreasing agent injection subsystem including a degreasing agent supply in fluid communication with the duct subsystem and operable for selectively injecting at least one degreasing agent contained in the degreasing agent supply into the duct subsystem;
a degreasing controller module operatively connected to the at least one condition sensor and the degreasing agent injection subsystem, the degreasing controller module being configured for:
determining a set of one or more degreasing parameters based on the at least one sensed condition; and
operating the degreasing agent injecting subsystem to inject the degreasing agent into the duct subsystem according to the set of one or more degreasing parameters.

67. The kitchen ventilation system of claim 66, wherein the sensed at least one operating condition comprises at least one of a type of cooking emissions received within the kitchen ventilation system and a quantity of cooking emissions received within the kitchen ventilation system.

68. The kitchen ventilation system of claim 67, wherein the at least one condition sensor comprises one or more optical sensors; and
wherein the at least one of the type of emissions received within the kitchen ventilation system and the quantity of emissions received within the kitchen ventilation system is sensed by the one or more optical sensors.

69. The kitchen ventilation system of claim 67 or 68, wherein the one or more degreasing parameters comprises at least one of an amount of the degreasing agent to be injected and the type of the degreasing agent to be injected.

70. The kitchen ventilation system of any one of claims 66 to 69, wherein the at least one condition sensor is configured to sense the at least one operating condition by tracking the operating condition over a tracking interval of time.

71. The kitchen ventilation system of claim 70, wherein the at least one condition sensor is configured to perform tracking of the operating condition over a duration of the tracking interval of time of greater than a week.

72. The kitchen ventilation system of claim 70 or 71, wherein the plurality of subsystems of the kitchen ventilation system comprises an airflow subsystem operatively connected and controllable by the degreasing controller module;
wherein the at least one tracked operating condition comprises a speed of the airflow subsystem and a presence of cooking emissions received within the duct subsystem; and
wherein the degreasing controller module is configured to determine the set of one or more degreasing parameters by:
identifying within the tracked operating conditions at least one degreasing-effective time interval during which the airflow subsystem is operating at a substantially low speed or is turned off and there is a non-presence of cooking emissions; and
defining degreasing parameters to schedule carrying out degreasing effective for degreasing an inlet region of the duct subsystem during a future degreasing time interval corresponding to the identified degreasing-effective time interval.

73. The kitchen ventilation system of claim 72, wherein the degreasing controller module is configured to identify the degreasing-effective time interval by identifying, within the tracked operating conditions, one or more time intervals each having a duration greater than four hours as effective for degreasing the inlet region of the duct subsystem.

74. The kitchen ventilation system of any one of claims 70 to 73, wherein the plurality of subsystems of the kitchen ventilation system comprises an airflow subsystem;
wherein the at least one tracked operating condition comprises a speed of the airflow subsystem of the kitchen ventilation system and a temperature within the kitchen ventilation system; and
wherein the degreasing controller module is configured to determine the set of one or more degreasing parameters by:
identifying within the tracked operating conditions at least one degreasing-effective time interval during which the airflow subsystem is operating at a substantially high speed and the temperature is greater than a predetermined temperature threshold; and
defining degreasing parameters to schedule carrying out degreasing effective for degreasing a region of the duct subsystem downstream of an inlet region during a future degreasing time interval corresponding to the identified degreasing-effective time interval.

75. The kitchen ventilation system of any one of claims 66 to 74, wherein at the plurality of subsystems of the kitchen ventilation system comprises a filter detection subsystem operatively connected to the degreasing controller and being operable to transmit a detected condition related to the presence of a filter at an inlet of the duct subsystem to the degreasing controller module; and
wherein the degreasing controller is further configured for:
detecting a presence of safe degreasing conditions from detecting the presence of the filter at the inlet of the duct subsystem of the kitchen ventilation system based on the transmitted detected condition.

76. The kitchen ventilation system of claim 75, wherein the degreasing controller is configured for preventing the operating of the degreasing agent injection subsystem to inject the degreasing agent into the duct subsystem unless a presence of safe degreasing conditions is detected.

77. The kitchen ventilation system of claim 75 or 76, wherein the filter detection subsystem comprises an occupancy sensor positioned at the inlet of the duct subsystem being operable to detect the presence of the filter.

78. The kitchen ventilation system of claim 75 or 76, wherein the plurality of subsystems of the kitchen ventilation system comprises an airflow subsystem being operatively connected to and controllable by the degreasing controller module and being operable to cause airflow through the duct subsystem; and
wherein the filter detection subsystem comprises an air pressure sensor operable to measure an air pressure variation within the duct subsystem, the air pressure variation being the detected condition; and
wherein the degreasing controller is configured for detecting the presence of the filter by:
operating the airflow subsystem of the kitchen ventilation system at a substantially high speed;
measuring the air pressure variation within the duct subsystem of the kitchen ventilation system while operating the airflow subsystem at the substantially high speed;
detecting the presence of the filter if the measured air pressure variation exceeds an air pressure variation threshold.

79. The kitchen ventilation system of claim 78, wherein the degreasing controller is configured for also determining an operational state of the airflow subsystem from the measured air pressure variation exceeding the air pressure variation threshold.

80. The kitchen ventilation system of any one of claims 66 to 79, wherein the degreasing agent is a biological degreasing agent comprising at least one of bacteria and enzymes.

81. A degreasing-enabled kitchen ventilation system comprising:
a plurality of subsystems including:
a duct subsystem having an inlet;
a degreasing agent injection subsystem including a degreasing agent supply in fluid communication with the kitchen ventilation system and operable for selectively injecting at least one degreasing agent contained in the degreasing agent supply into the duct subsystem; and
a filter detection subsystem operable to detect a condition related to a presence of a filter at the inlet of the duct subsystem;
a degreasing controller module operatively connected to the degreasing agent injection subsystem and the filter detection subsystem to receive the detected condition therefrom, the degreasing controller configured for:
detecting a presence of safe degreasing conditions from detecting the presence of a filter at the inlet of the duct subsystem of the kitchen ventilation system based on the received detected condition.

82. The kitchen ventilation system of claim 81, wherein the degreasing controller is configured for preventing operation of the degreasing agent injection subsystem to inject the degreasing agent into the duct subsystem unless a presence of safe degreasing conditions is detected.

83. The kitchen ventilation system of claim 81 or 82, wherein the filter detection subsystem comprises an occupancy sensor positioned at the inlet of the duct subsystem being operable to detect the presence of the filter.

84. The kitchen ventilation system of claim 81 or 82, wherein the plurality of subsystems of the kitchen ventilation system comprises an airflow subsystem being operatively connected to and controllable by the degreasing controller module and being operable to cause airflow through the duct subsystem; and
wherein the filter detection subsystem comprises an air pressure sensor operable to measure the air pressure variation within the duct subsystem; and
wherein the degreasing controller is configured for detecting the presence of the filter by:
operating the airflow subsystem of the kitchen ventilation system at a substantially high speed;
measuring the air pressure variation within the duct subsystem of the kitchen ventilation system while operating the airflow subsystem at the substantially high speed;
detecting the presence of the filter if the measured air pressure variation exceeds an air pressure variation threshold.

85. The kitchen ventilation system of claim 84, wherein the degreasing controller is configured for also determining an operational state of the airflow subsystem from the measured air pressure variation exceeding the air pressure variation threshold.

86. The kitchen ventilation system of any one of claims 81 to 85, wherein the degreasing agent is a biological degreasing agent comprising at least one of bacteria and enzymes.
